(19) United States
(12) Patent Application Publication
(10) Pub. No.: US 2020/0094825 A1
(43) Pub. Date: Mar. 26, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Daichi Kato, Wako-shi (JP)

(21) Appl. No.: 16/569,681

(22) Filed: Sep. 13, 2019

(30) Foreign Application Priority Data
Sep. 26, 2018 (JP) 2018-180895

(51) Int. Cl. B60W 30/12; B60W 40/08; B60W 10/18; B60W 10/20

(52) U.S. Cl. CPC B60W 30/12; B60W 10/20; B60W 10/18; B60W 40/08

(57) ABSTRACT

A vehicle control device includes a travel path boundary position setter configured to set a travel path boundary position that affects vehicle control in a road width direction on the basis of an output of an in-vehicle sensor, and a driving controller configured to control at least steering on the basis of the output of the in-vehicle sensor, wherein the driving controller is configured to calculate an index value indicating a variation over time in the travel path boundary position set by the travel path boundary position setter or a variation in a position of the road width direction related to a distance from a vehicle in a traveling direction and set a control range in the road width direction which is larger when the calculated index value is less than a threshold value than when the index value is greater than or equal to the threshold value.

### CROSS-REFERENCE TO RELATED APPLICATION

Priority is claimed on Japanese Patent Application No. 2018-180895, filed Sep. 26, 2018, the content of which is incorporated herein by reference.

### BACKGROUND

### Field of the Invention

The present invention relates to a vehicle control device, a vehicle control method, and a storage medium.

### Description of Related Art

In recent years, research on automatically controlling driving of a vehicle has been conducted. In relation thereto, technology for moving and stopping a vehicle in a road width direction is known (for example, Japanese Unexamined Patent Application, First Publication No. 2007-331652).

### SUMMARY

Here, when there is an obstacle in a moving direction of a vehicle, it is preferable that the movement in the direction be limited. However, in conventional technology, because the presence or absence of an obstacle is determined on the basis of an image acquired at a certain timing and a detection result of a sensor, it may not be possible to appropriately detect an obstacle according to an imaging condition of an image or a detection timing of the sensor and it may be difficult to limit movement in a corresponding direction.

An aspect of the present invention have been made in view of such circumstances and an objective of the aspect of the present invention is to provide a vehicle control device, a vehicle control method, and a storage medium capable of causing a vehicle to be moved in a more appropriate situation.

A vehicle control device, a vehicle control method, and a storage medium according to the present invention adopt the following configurations.

(1): According to an aspect of the present invention, there is provided a vehicle control device including: a travel path boundary position setter configured to set a travel path boundary position that affects vehicle control in a road width direction on the basis of an output of an in-vehicle sensor; and a driving controller configured to control at least steering on the basis of the output of the in-vehicle sensor, wherein the driving controller is configured to calculate an index value indicating a variation over time in the travel path boundary position set by the travel path boundary position setter or a variation in a position of the road width direction related to a distance from a vehicle in a traveling direction and set a control range in the road width direction which is larger when the calculated index value is less than a threshold value than when the index value is greater than or equal to the threshold value.

(2): In the above-described aspect (1), the travel path boundary position setter is configured to set the travel path boundary position in an extending direction of a road, and the driving controller is configured to derive an index value on the basis of a variation in a position corresponding to a prescribed distance in the traveling direction of the vehicle among travel path boundary positions set in the extending direction.

(3): In the above-described aspects (1), the in-vehicle sensor includes at least one of a light detection and ranging (LIDAR) finder and an imaging device.

(4): In the above-described aspect (1), the travel path boundary position setter is configured to set the travel path boundary position on each of one side and the other side in the road width direction in the traveling direction of the vehicle, the driving controller is configured to determine a control range in the road width direction related to a left side of the vehicle on the basis of the index value obtained from a left travel path boundary position set on the left side of the vehicle by the travel path boundary position setter, and the driving controller is configured to determine a control range in the road width direction related to a right side of the vehicle on the basis of the index value obtained from a right travel path boundary position set on the right side of the vehicle by the travel path boundary position setter.

(5): In the above-described aspects (1), the driving controller is configured to not reduce the control range when the index value is greater than or equal to the threshold value as compared with when the index value is less than the threshold value if a distance in the road width direction between a center of a lane or a central axis of the vehicle and the travel path boundary position is greater than or equal to a prescribed distance.

(6): In the above-described aspects (1), the vehicle control device further includes a surrounding environment recognizer configured to recognize a surrounding environment of the vehicle, wherein the driving controller is configured to activate a first driving state for controlling the vehicle so that the vehicle travels in a lane or along a travel path indicated by a trajectory of a preceding vehicle in front of the vehicle on the basis of a recognition result of the surrounding environment recognizer and a second driving state for causing the vehicle to travel to a travel limit set on the basis of a marker recognized by the surrounding environment recognizer and causing the vehicle to be decelerated or stopped, and wherein the control range in the road width direction is applied to the second driving state.

(7): In the above-described aspect (6), the vehicle control device further includes an estimator configured to estimate a state of a driver of the vehicle, wherein the driving controller is configured to execute the second driving state when a prescribed state is given.

(8): In the above-described aspects (6), the driving controller is configured to execute the second driving state when a driver does not respond to a call of the vehicle.

(9): In the above-described aspects (1), the driving controller further is configured to determine the control range in the road width direction on the basis of map information.

(10): According to an aspect of the present invention, there is provided a vehicle control device including: a travel path boundary position setter configured to set a travel path boundary position that affects vehicle control in a road width direction on the basis of an output of an in-vehicle sensor; and a calculator configured to calculate an index value indicating a variation over time in the travel path boundary position set by the travel path boundary position setter or a variation in a position of a road width direction related to a distance from a vehicle in a traveling direction, wherein the travel path boundary position setter corrects the travel path boundary position inward in the road width direction when the index value calculated by the calculator is less than a threshold value as compared with when the index value is greater than or equal to the threshold value at the time of execution of specific vehicle control.

(11): According to an aspect of the present invention, there is provided a vehicle control method including: setting, by a computer, a travel path boundary position that affects vehicle control in a road width direction on the basis of an output of an in-vehicle sensor; controlling, by the computer, at least steering on the basis of the output of the in-vehicle sensor; calculating, by the computer, an index value indicating a variation over time in the set travel path boundary position or a variation in a position of the road width direction related to a distance from a vehicle in a traveling direction; and setting, by the computer, a control range in the road width direction which is larger when the calculated index value is less than a threshold value than when the index value is greater than or equal to the threshold value.

(12): According to an aspect of the present invention, there is provided a storage medium storing a program for causing a computer to: cause a travel path boundary position at which a vehicle is able to travel in a road width direction to be set on the basis of an output of an in-vehicle sensor; cause at least steering to be controlled on the basis of the output of the in-vehicle sensor; cause an index value indicating a variation over time in the set travel path boundary position or a variation in a position of the road width direction related to a distance from the vehicle in a traveling direction to be calculated; and cause a control range in the road width direction which is larger when the calculated index value is less than a threshold value than when the index value is greater than or equal to the threshold value to be set.

According to the above-described aspects (1) to (12), it is possible to move a vehicle in a more appropriate situation.

### BRIEF DESCRIPTION OF THE DRAWINGS

FIG. 1 is a configuration diagram of an in-vehicle system using a vehicle control device according to the present embodiment.

FIG. 2 is a functional configuration diagram of a first controller and a second controller.

FIG. 3 is a diagram showing an example of a captured image captured by a camera of a host vehicle.

FIG. 4 is a flowchart showing an example of a flow of a process of limiting a control range according to the present embodiment.

FIG. 5 is a diagram showing an example of a relationship between a marker position and a travel path boundary position in a scene of FIG. 3.

FIG. 6 is a diagram showing an example of a left travel path boundary line before correction in scenes of FIGS. 3 and 5.

FIG. 7 is a view showing an example of a left travel path boundary line after correction in the scene of FIG. 6.

FIG. 8 is a graph showing a result of calculating an index value in an index value calculator.

FIG. 9 is a diagram schematically showing another example of a process of calculating the index value in the index value calculator.

FIG. 10 is a diagram schematically showing another example of a process of limiting a control range.

FIG. 11 is a flowchart showing an example of a flow of a process of limiting a control range according to modified example 1.

FIG. 12 is a diagram showing an example of a corrected travel path boundary position.

FIG. 13 is a diagram showing an example of a hardware configuration of an automated driving control device.

### DESCRIPTION OF EMBODIMENTS

Embodiments of a vehicle control device, a vehicle control method, and a storage medium of the present invention will be described below with reference to the drawings. Although a case in which left-hand traffic regulations are applied will be described below, it is only necessary to reverse the left and right when right-hand traffic regulations are applied.

### EMBODIMENTS

### [Overall Configuration]

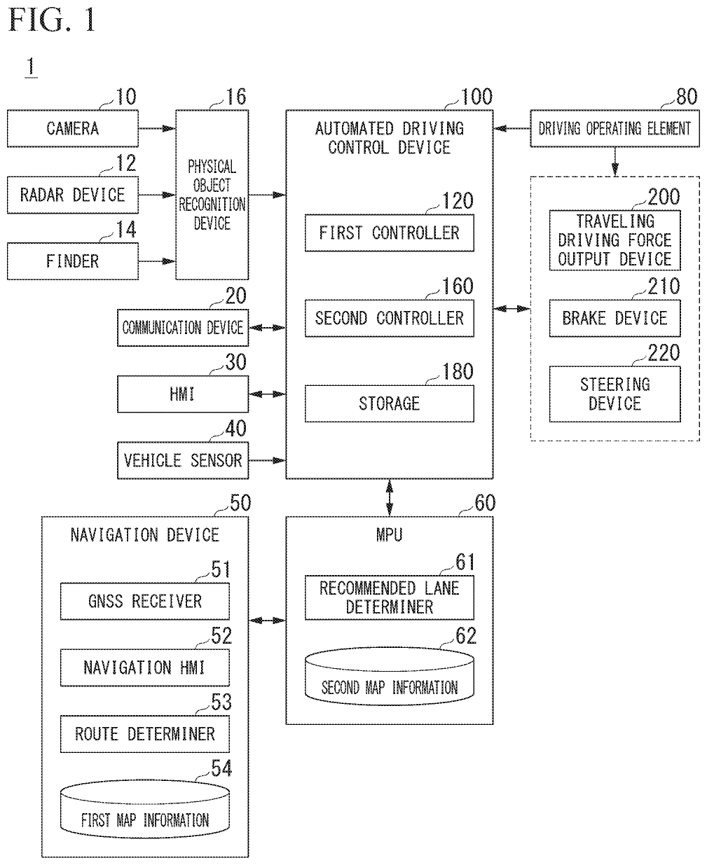

FIG. 1 is a configuration diagram of an in-vehicle system 1 using a vehicle control device according to the present embodiment. A vehicle equipped with the in-vehicle system 1 is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

The in-vehicle system 1 includes, for example, a camera 10, a radar device 12, a finder 14, a physical object recognition device 16, a communication device 20, a human machine interface (HMI) 30, a vehicle sensor 40, a navigation device 50, a map positioning unit (MPU) 60, a speaker 70, a driving operating element 80, an automated driving control device 100, a traveling driving force output device 200, a brake device 210, and a steering device 220. These devices and apparatuses are connected to each other by a multiplex communication line such as a controller area network (CAN) communication line, a serial communication line, a wireless communication network, or the like. Also, the configuration shown in FIG. 1 is merely an example, and a part of the configuration may be omitted or another configuration may be further added.

For example, the camera 10 is a digital camera using a solid-state imaging device such as a charge coupled device (CCD) or a complementary metal oxide semiconductor (CMOS). The camera 10 is attached to any position on a vehicle on which the in-vehicle system 1 is mounted (hereinafter referred to as the host vehicle M). When the view in front thereof is imaged, the camera 10 is attached to an upper portion of a front windshield, a rear surface of a rearview mirror, or the like. When the view to the rear thereof is imaged, the camera 10 is attached to an upper portion of a rear windshield, or the like. For example, the camera 10 periodically and iteratively images the vicinity of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any positions on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position of the host vehicle M.

In the present embodiment, the finder 14 radiates and receives light so that a light radiation direction is changed every prescribed time by an actuator (not shown) and the surroundings of the host vehicle M are scanned in a horizontal direction.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the in-vehicle system 1.

The communication device 20 communicates with other vehicles present in the vicinity of the host vehicle M using, for example, a cellular network, a Wi-Fi network, Bluetooth (registered trademark), dedicated short range communication (DSRC), or the like or communicates with various types of server devices via a wireless base station.

The HMI 30 presents various types of information to an occupant of the host vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect speed of the host vehicle M, an acceleration sensor configured to detect acceleration, a yaw rate sensor configured to detect angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like.

The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by an occupant.

The navigation device 50 may transmit a current position and a destination to a navigation server via the communication device 20 and acquire a route equivalent to the route on the map from the navigation server.

For example, the MPU 60 includes as a recommended lane determiner 61 and stores second map information 62 in a storage device such as an HDD or a flash memory.

The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines on what lane numbered from the left the vehicle will travel.

The recommended lane determiner 61 determines the recommended lane so that the host vehicle M can travel along a reasonable route for traveling to a branch destination when there is a branch point in the route on the map.

The second map information 62 is map information which has higher accuracy than the first map information 54. For example, the second map information 62 includes information about a center of a lane, information about a boundary of a lane, or the like. The second map information 62 may include road information, traffic regulations information, address information (an address/zip code), facility information, telephone number information, and the like. The second map information 62 may be updated at any time when the communication device 20 communicates with another device.

For example, the driving operating element 80 includes an accelerator pedal, a brake pedal, a shift lever, a steering wheel, a steering wheel variant, a joystick, a direction indicator lever, a microphone, various types of switches, and the like. A sensor configured to detect an amount of operation or the presence or absence of an operation is attached to the driving operating element 80, and a detection result thereof is output to the automated driving control device 100 or some or all of the traveling driving force output device 200, the brake device 210, and the steering device 220.

For example, the automated driving control device 100 includes a first controller 120, a second controller 160, and a storage 180. For example, the first controller 120 and the second controller 160 are implemented by a hardware processor such as a central processing unit (CPU) executing a program (software). Some or all of these components are implemented, for example, by hardware (a circuit unit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or flash memory of the storage 180 or pre-stored in a removable storage medium such as a DVD or a CD-ROM. The program may be installed in an HDD or flash memory of the automated driving control device 100 when the storage medium is mounted in a drive device.

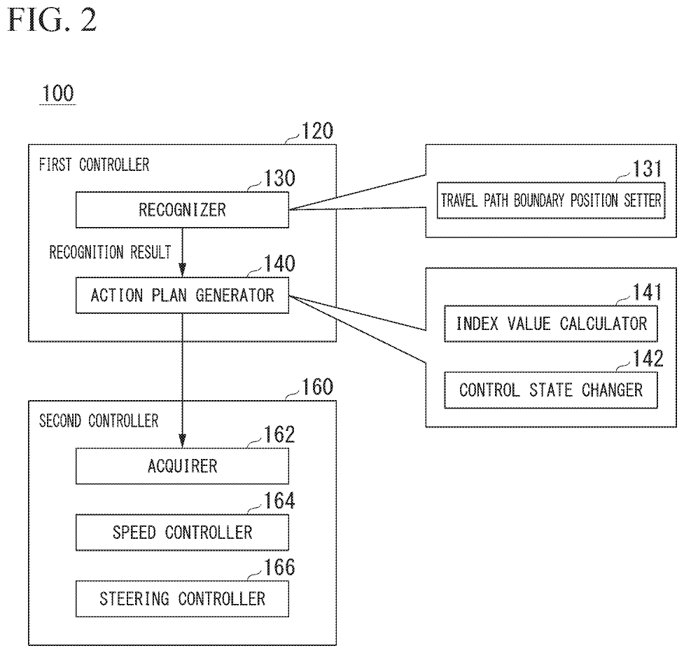

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals capable of pattern matching, road signs, or the like) in parallel and performing comprehensive evaluation by assigning scores to both the recognitions. Thereby, the reliability of automated driving is secured.

The recognizer 130 recognizes states of a position, a speed, acceleration, and the like of a physical object present in the vicinity of the host vehicle M on the basis of information input from the camera 10, the radar device 12, and the finder 14 via the physical object recognition device 16. The physical object includes other vehicles. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane (a travel lane) in which the host vehicle M is traveling. For example, the recognizer 130 recognizes the travel lane by comparing a pattern of a road dividing line (for example, an arrangement of solid lines and broken lines) obtained from the second map information 62 with a pattern of a road dividing line in the vicinity of the host vehicle M recognized from an image captured by the camera 10. The recognizer 130 may recognize a travel lane by recognizing a travel path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. The recognizer 130 recognizes a temporary stop line, an obstacle, red traffic light, a toll gate, and other road events.

When the travel lane is recognized, the recognizer 130 recognizes a position or orientation of the host vehicle M with respect to the travel lane. For example, the recognizer 130 may recognize a deviation of a representative point of the host vehicle M from the center of the lane and an angle formed with respect to a line connecting the center of the lane in the traveling direction of the host vehicle M as a relative position and an orientation of the host vehicle M related to the travel lane. Instead, the recognizer 130 may recognize a position of the representative point of the host vehicle M related to one side end portion (a road dividing line or a road boundary) of the travel lane or the like as a relative position of the host vehicle M related to the travel lane.

The recognizer 130 further includes a travel path boundary position setter 131. The travel path boundary position setter 131 sets a travel path boundary position (hereinafter referred to as a travel path boundary position LP) that affects vehicle control on the basis of information input from the camera 10, the radar device 12, and the finder 14 via the physical object recognition device 16. The travel path boundary position is, for example, a limit position where the vehicle can travel in the road width direction of the travel lane of the host vehicle M. In the following description, the travel path boundary position LP on a left side in the road width direction is referred to as a left travel path boundary position LPL, the travel path boundary position LP on a right side in the road width direction is referred to as a right travel path boundary position LPR, and the left travel path boundary position LPL and the right travel path boundary position LPR are simply referred to as travel path boundary positions LP when they are not distinguished from each other. In the following description, a case in which the travel path boundary position setter 131 uses information particularly input from the finder 14 via the physical object recognition device 16 among pieces of information input from the camera 10, the radar device 12, and the finder 14 via the physical object recognition device 16 will be described. Details of the process of the travel path boundary position setter 131 will be described below.

The action plan generator 140 generates a future target trajectory for causing the host vehicle M to automatically travel (independently of a driver's operation) so that the host vehicle M can generally travel in the recommended lane determined by the recommended lane determiner 61 and further cope with a surrounding situation of the host vehicle M. The target trajectory includes, for example, a speed element. For example, the target trajectory is represented as a sequence of points (trajectory points) at which the host vehicle M is required to arrive. The trajectory point is a point at which the host vehicle M is required to arrive for each prescribed traveling distance (for example, about several meters [m]) along a road. Alternatively, a target speed and target acceleration for each prescribed sampling time (for example, about several tenths of a second [sec]) are generated as a part of the target trajectory. The trajectory point may be a position at which the host vehicle M is required to arrive at the sampling time for each prescribed sampling time. In this case, information of the target speed or the target acceleration is represented by an interval between the trajectory points.

The action plan generator 140 may set an automated driving event when the target trajectory is generated. In the automated driving event, there are a constant-speed driving event, a low-speed following driving event for performing traveling while following a preceding vehicle at a prescribed vehicle speed (for example, 60 [km]) or less, a lane change event, a branching event, a merging event, a takeover event, and the like. The action plan generator 140 generates a target trajectory according to an activated event.

The action plan generator 140 further includes an index value calculator 141 and a control state changer 142.

The index value calculator 141 calculates an index value sv indicating a variation over time in the travel path boundary position LP set by the travel path boundary position setter 131. For example, the index value calculator 141 calculates a left index value svL on the basis of the left travel path boundary position LPL and calculates a right index value svR on the basis of the right travel path boundary position LPR. In the following description, the left index value svL and the right index value svR are simply referred to as index values sv when they are not distinguished from each other. Details of a process of the index value calculator 141 will be described below.

The control state changer 142 limits a control range in the road width direction on the basis of the index value sv calculated by the index value calculator 141. Specifically, the control state changer 142 limits the control range in a left direction on the basis of the left index value svL calculated by the index value calculator 141 and limits the control range in a right direction on the basis of the right index value svR. The control range is a range in which the host vehicle M can travel when the automated driving control device 100 controls the host vehicle M. Details of a process of the control state changer 142 will be described below.

The second controller 160 controls the traveling driving force output device 200, the brake device 210, and the steering device 220 so that the host vehicle M passes through the target trajectory generated by the action plan generator 140 at scheduled times.

The second controller 160 includes, for example, an acquirer 162, a speed controller 164, and a steering controller 166. The acquirer 162 acquires information about the target trajectory (trajectory points) generated by the action plan generator 140 and causes the information to be stored in a memory (not shown). The speed controller 164 controls the traveling driving force output device 200 or the brake device 210 on the basis of speed elements associated with the target trajectory stored in the memory. The steering controller 166 controls the steering device 220 in accordance with a degree of curvature of the target trajectory stored in the memory. For example, processes of the speed controller 164 and the steering controller 166 are implemented by a combination of feed-forward control and feedback control. As one example, the steering controller 166 combines and executes feed-forward control according to the curvature of the road in front of the host vehicle M and feedback control based on a deviation from the target trajectory. A combination of the action plan generator 140 and the second controller 160 is an example of a “driving controller”.

The traveling driving force output device 200 outputs a traveling driving force (a torque) to driving wheels so as to allow the vehicle to travel. For example, the traveling driving force output device 200 includes a combination of an internal combustion engine, an electric motor, a transmission, and the like, and an ECU configured to control them. The ECU controls the above-described configuration in accordance with information input from the second controller 160 or information input from the driving operating element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with information input from the second controller 160 or information input from the driving operating element 80 so that a brake torque according to a braking operation is output to each wheel. The brake device 210 may include a mechanism for transferring the hydraulic pressure generated by the operation of the brake pedal included in the driving operating element 80 to the cylinder via the master cylinder as a backup. The brake device 210 is not limited to the above-described configuration and may be an electronically controlled hydraulic brake device that controls an actuator in accordance with information input from the second controller 160 and transfers the hydraulic pressure of the master cylinder to the cylinder.

For example, the steering device 220 includes a steering ECU and an electric motor.

The electric motor, for example, changes a direction of the steering wheels by applying a force to a rack and pinion mechanism. The steering ECU drives the electric motor and causes the direction of the steering wheels to be changed in accordance with the information input from the second controller 160 or the information input from the driving operating element 80.

### [In Terms of Position Suitable for Traveling and Stopping of Host Vehicle M]

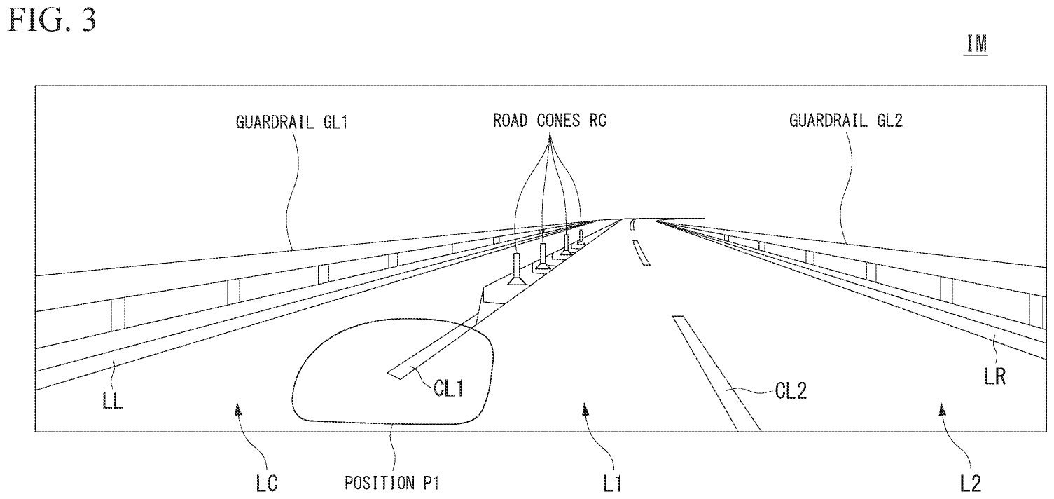

FIG. 3 is a diagram showing an example of a captured image IM captured by the camera 10 of the host vehicle M. As shown in FIG. 3, a first lane L1, a second lane L2, and a branch lane LC branching from the first lane L1 are shown in the captured image IM. The branch lane LC is a lane separated off by a road dividing line LL and a road dividing line CL1, the first lane L1 is a lane separated off by the road dividing line CL1 and a road dividing line CL2, and the second lane L2 is a lane separated off by the road dividing line CL2 and a road dividing line LR.

In FIG. 3, the travel lane of the host vehicle M is the first lane L1 and a target trajectory of the host vehicle M is a trajectory in which the host vehicle M travels straight ahead in the first lane L1. A guardrail GL1 is installed on the left side of the branch lane LC in an extending direction of the branch lane LC and a guardrail GL2 is installed on the right side of the second lane L2 in an extending direction of the second lane L2. A plurality of markers (road cones RC which are shown) for preventing entry from the first lane L1 into the branch lane LC after a branch point are installed between the first lane L1 and the branch lane LC.

Here, the in-vehicle system 1 may change a target trajectory, take the host vehicle M outside of the first lane L1 (for example, a left end or a road shoulder of the first lane L1 (a position P1 which is shown)), or stop the host vehicle M at the outside of the first lane L1 according to an instruction of an occupant or a surrounding situation of the host vehicle M. However, in a scene shown in FIG. 3, there is a branch to the branch lane LC and there is a possibility that vehicle control will become complicated due to a situation where the road cones RC suddenly appear on the road or the like. Thus, the in-vehicle system 1 limits the control range in the road width direction when the index value sv satisfies a certain condition at the time of execution of specific control. The specific control is, for example, minimal risk maneuver (MRM). The MRM is, for example, a driving state aiming to minimize the risk associated with the traveling of the host vehicle M.

As a result, the control range when the specific control is performed and the control range is limited is set to be smaller than the control range when the specific control is not performed. In other words, the control range when the specific control is not performed is set to be larger than that when the specific control is performed and the control range is limited.

The automated driving control device 100 controls the host vehicle M in at least either a first driving state or a second driving state. The first driving state is a driving state in which the traveling of the host vehicle M is controlled by a following traveling control function or a driving support function. In the first driving state, the host vehicle M travels in the lane divided by the road dividing lines (the first lane L1 in the present example). The second driving state is a driving state in which the specific control is performed. In the first driving state, the automated driving control device 100 may control the host vehicle M so that the host vehicle M travels along a travel path indicated by a trajectory of a preceding vehicle of the host vehicle M in addition to the lane.

For example, the automated driving control device 100 executes a process of causing the host vehicle M to travel, decelerate, or stop in the vicinity of the travel path boundary position LP as the MRM. A prescribed condition when the MRM is performed is, for example, a case in which a driver of the host vehicle M does not respond to a call for a driving change from the in-vehicle system 1 (condition 1), a case in which it is estimated that the driver of the host vehicle M cannot drive the host vehicle M (condition 2), or a case in which at least some of the functions of the in-vehicle system 1 have failed (condition 3).

The control state changer 142 determines whether or not the driver of the host vehicle M has responded to the call for the driving change from the in-vehicle system 1 (condition 1), for example, by means of a grip sensor provided in the steering. For example, the control state changer 142 determines whether or not the state is a state in which it is estimated that the driver of the host vehicle M cannot drive the host vehicle M on the basis of a captured image captured by the in-vehicle camera provided within the vehicle of the host vehicle M (condition 2). For example, the control state changer 142 executes a self-inspection program constantly or at prescribed time intervals and determines whether or not at least some of the functions of the in-vehicle system 1 have failed (condition 3). The control state changer 142 executes the MRM when any one of (condition 1) to (condition 3) is satisfied. However, when the index value sv calculated by the index value calculator 141 satisfies the prescribed condition, the control range is limited (a process of preventing the host vehicle M from traveling in the vicinity of the travel path boundary position LP is performed).

### [In Terms of Limit of Control Range in Road Width Direction]

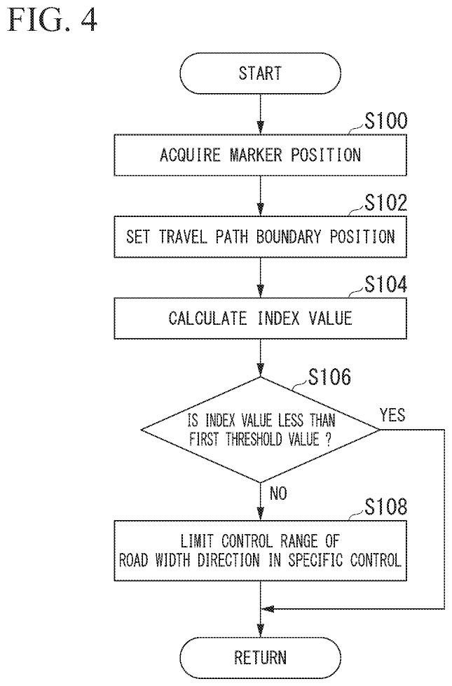

Hereinafter, a limit of the control range will be described. FIG. 4 is a flowchart showing an example of a flow of a process of limiting the control range according to the present embodiment. First, the travel path boundary position setter 131 acquires information indicating a marker position OP input from the finder 14 via the physical object recognition device 16 (step S100). The marker position OP is a position where it is estimated that there is a marker reflecting light radiated from the finder 14. Next, the travel path boundary position setter 131 sets a travel path boundary position LP on the basis of the acquired marker position OP (step S102).

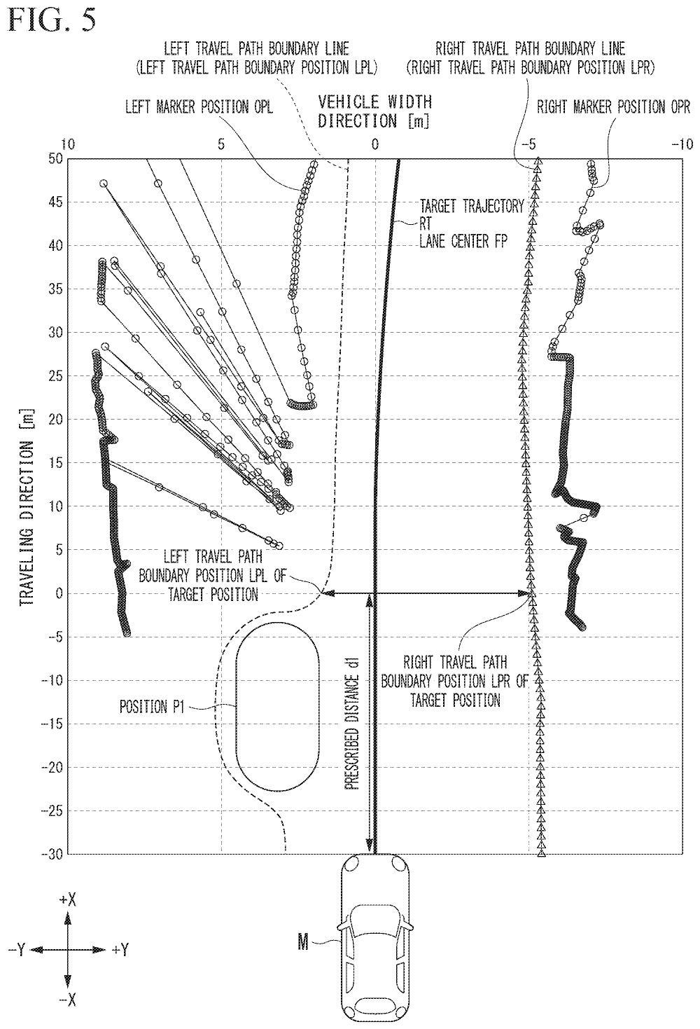

Hereinafter, the flow of the process described with reference to FIG. 4 will be described more specifically. FIG. 5 is a diagram showing an example of a relationship between the marker position OP and the travel path boundary position LP in the scene of FIG. 3. In the following description, it is assumed that X indicates an extending direction of a road, and Y indicates a road width direction orthogonal to the X direction. A +X direction is a traveling direction of the host vehicle M, a −X direction is a backward direction of the host vehicle M, a −Y direction is a left direction in the traveling direction of the host vehicle M, and a +Y direction is a right direction in the traveling direction when the host vehicle M travels in the extending direction of the road. In the following description, in the Y direction, a direction toward a lane center FP of the travel lane of the host vehicle M (the first lane L1 in this case) may be referred to as an inward direction or as being inward and a direction away from the lane center FP may be referred to as an outward direction or as being outward.

A lateral scale shown in FIG. 5 indicates a distance from the host vehicle M so that a positive value is taken in the left direction around the position of the host vehicle M and a negative value is taken in the right direction with respect to the road width direction for description. A left marker position OPL shown in FIG. 5 is a position of a marker which the travel path boundary position setter 131 classifies as the marker position OP present on the left side of the host vehicle M when viewed from the host vehicle M. A right marker position OPR shown in FIG. 5 is a position of a marker which the travel path boundary position setter 131 classifies as the marker position OP present on the right side of the host vehicle M when viewed from the host vehicle M. The travel path boundary position setter 131 uses the left marker position OPL to set the left travel path boundary position LPL and uses the right marker position OPR to set the right travel path boundary position LPR. In the following description, a line connecting left travel path boundary positions LPL is referred to as a left travel path boundary line, a line connecting right travel path boundary positions LPR is referred to as a right travel path boundary line, and the left travel path boundary line and the right travel path boundary line are simply referred to as limit lines when they are not distinguished from each other.

In principle, the travel path boundary position setter 131 extracts an innermost marker position OP of the marker positions OP every prescribed distance (for example, several to several tens of centimeters [cm]) related to the X direction with respect to each of the left and right sides, and sets a position inward separated (offset) by a standard distance (for example, several to several tens of centimeters [cm]) from the extracted marker position OP as the travel path boundary position LP. The travel path boundary position setter 131 may smooth the limit line represented by the set travel path boundary position LP and set a position which is on the smoothed limit line and is provided every prescribed distance (for example, several to several tens of centimeters [cm]) related to the X direction as the travel path boundary position LP.

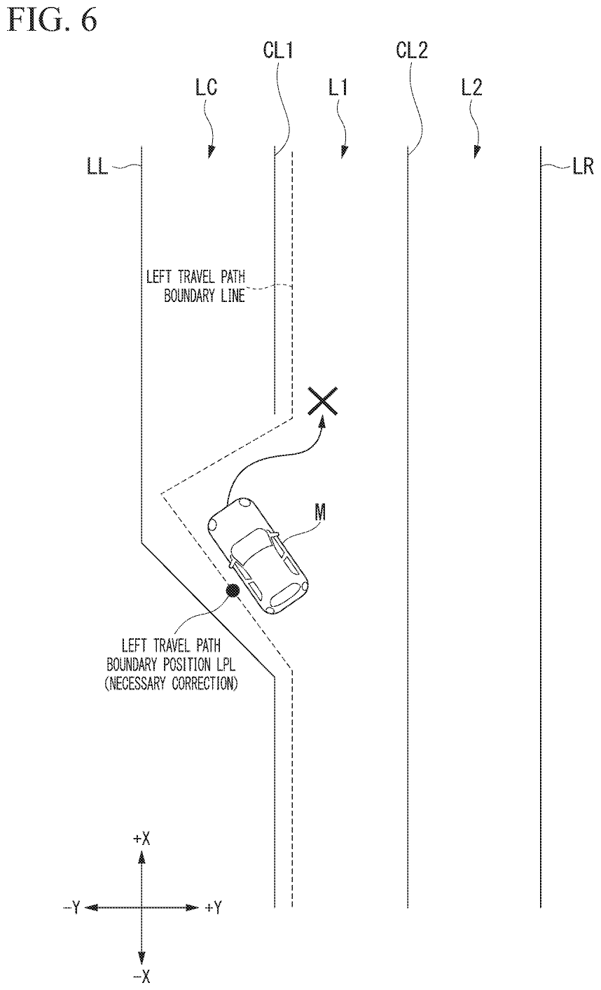

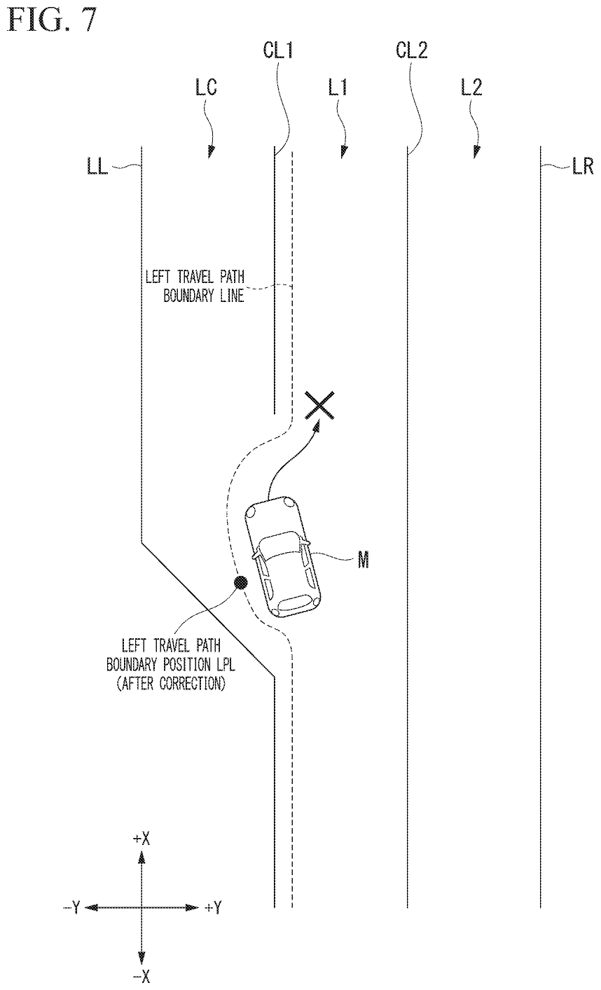

The right travel path boundary line shown in FIG. 5 is set in accordance with this principle. On the other hand, the left travel path boundary line shown in FIG. 5 is a left travel path boundary line after correction to be described below is performed. When the host vehicle M cannot perform traveling while following the travel path boundary positions LP using the turning performance of the host vehicle M, the travel path boundary position setter 131 corrects a point or a part of a line projecting outside the travel path boundary positions LP in the inward direction. Hereinafter, a case in which the travel path boundary position setter 131 corrects the left travel path boundary position LPL will be described with reference to FIGS. 6 and 7. Also, when the right travel path boundary position LPR is corrected, a process is similar to a process of correcting the left travel path boundary position LPL, so that it is only necessary to read the following description by interchanging left and right.

FIG. 6 is a diagram showing an example of the left travel path boundary line before correction in the scenes of FIGS. 3 and 5. The left travel path boundary line shown in FIG. 6 is a line connecting the left travel path boundary positions LPL set by the travel path boundary position setter 131 in accordance with a principle. As described above, the host vehicle M does not travel in the branch lane LC to go straight ahead in the first lane L1. Therefore, the left travel path boundary line shown in FIG. 6 has a shape extending along the first lane L1 and projecting to the entrance of the branch lane LC.

When the host vehicle M travels along the left travel path boundary line shown in FIG. 6 and moves to the position of the shape projecting to the entrance of the branch lane LC, it is difficult to return to the target trajectory (i.e., the first lane L1) according to turning. Thus, the travel path boundary position setter 131 determines whether or not it is possible to return to the target trajectory according to turning with respect to each left travel path boundary position LPL included in the left travel path boundary line, and corrects the left travel path boundary position LPL inward when it is not possible to return to the target trajectory. FIG. 7 is a diagram showing an example of the left travel path boundary line after correction in the scene of FIG. 6. As shown in FIG. 7, the left travel path boundary position LPL included in the left travel path boundary line after correction is set inward as compared with the left travel path boundary position LPL included in the left travel path boundary line before correction.

Returning to FIG. 4, the index value calculator 141 calculates the index value sv on the basis of the travel path boundary position LP acquired by the travel path boundary position setter 131 (step S104).

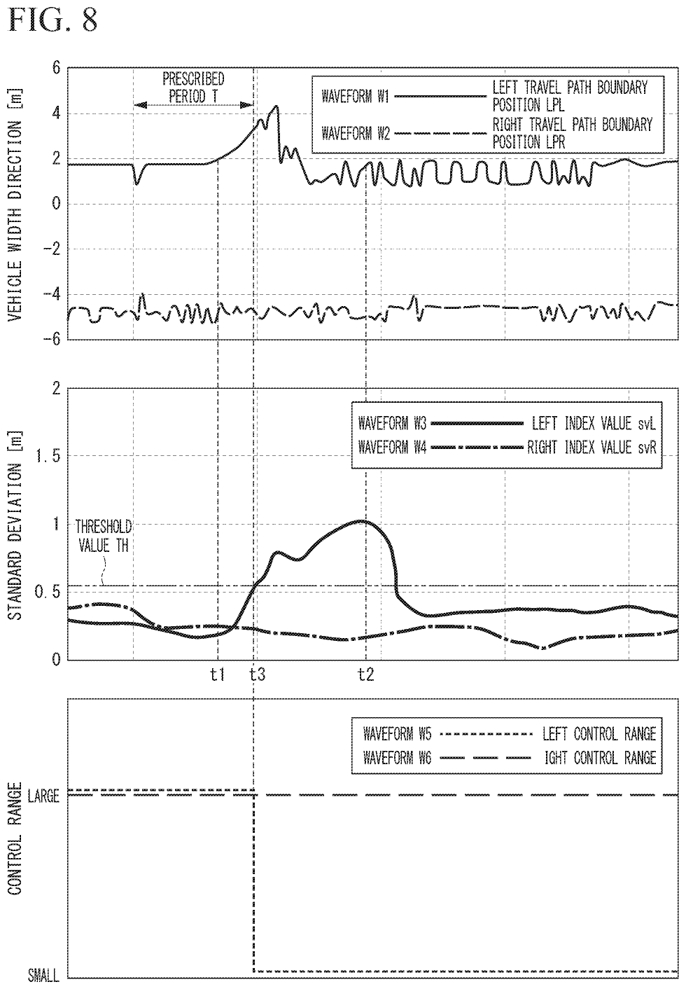

Hereinafter, the flow of the process described with reference to FIG. 4 will be described more specifically. FIG. 8 is a graph showing a result of calculating the index value sv in the index value calculator 141. The vertical axis in FIG. 8 corresponds to the horizontal scale shown in FIG. 5 and is an axis for which a positive value is taken in the left direction around the position of the host vehicle M and a negative value is taken in the right direction with respect to the road width direction, and is an axis indicating a distance to the travel path boundary position LP when setting the position of the host vehicle M to 0 [m]. The horizontal axis represents time.

A waveform W1 shown in FIG. 8 is a waveform indicating a change over time in the left travel path boundary position LPL which is a position separated by a prescribed distance d1 (for example, 30 [m]) from the host vehicle M (hereinafter referred to as a target position (see FIG. 5)) among the left travel path boundary positions LPL set by the travel path boundary position setter 131. A waveform W2 is a waveform indicating a change over time in the right travel path boundary position LPR of the target position (see FIG. 5) among the right travel path boundary positions LPR set by the travel path boundary position setter 131. As shown in FIG. 3, the guardrail GL2 is only present as a marker on the right side of the host vehicle M and a plurality of road cones RC other than the guardrail GL1 are installed as markers on the left side of the host vehicle M. Therefore, a change in a value of the waveform W1 (i.e., a variation in the road width direction) is larger between the change over time in the left travel path boundary position LPL indicated by the waveform W1 and the change over time in the right travel path boundary position LPR indicated by the waveform W2 in FIG. 8.

The index value calculator 141 acquires the travel path boundary position LP of the target position at each predetermined time interval and calculates a standard deviation of a plurality of travel path boundary positions LP acquired during an observation period from a time which is a prescribed period T earlier than an acquisition time to the acquisition time as the index value sv. The index value sv is an example of a “value indicating a variation over time in the travel path boundary position LP”. A waveform W3 shown in FIG. 8 is a waveform indicating a change over time in the left index value svL calculated by the index value calculator 141 and a waveform W4 is a waveform indicating a change over time in the right index value svR calculated by the index value calculator 141. As shown in the waveform W3, the left index value svL gradually increases from a time when the change in the value starts to occur in the waveform W1 (time t1 which is shown), increases until a time when the change in the value in the waveform W1 becomes a maximum (time t2 which is shown), and decreases and gradually converges after time t2. However, because the change in the value is also larger after time t2 in the waveform W1 compared with the waveform W2, the waveform W3 has a larger value than the waveform W4 even after the value converges after time t2.

Returning to FIG. 4, the control state changer 142 determines whether or not the index value sv calculated by the index value calculator 141 is less than a first threshold value TH1 (step S106). When it is determined that the index value sv is greater than or equal to the first threshold value TH1, the control state changer 142 limits the control range in the road width direction at the time of execution of specific control (for example, MRM) as compared with when the index value sv is less than the first threshold value TH1 (step S108). When it is determined that the index value sv is less than the first threshold value TH1, the control state changer 142 does not limit the control range in the road width direction at the time of execution of specific control. As a result, the control range in the road width direction is not limited as compared with when the index value sv is greater than or equal to the first threshold value TH1.

A state in which the index value sv is less than the first threshold value TH1 is, for example, a state in which the variation over time in the travel path boundary position LP is small and there is stability outside of the travel path boundary position LP. A state in which there is stability outside of the travel path boundary position LP is, for example, a state in which there are no obstacles on the road shoulder. Therefore, in this case, the control state changer 142 does not limit the control range and the automated driving control device 100 may cause the host vehicle M to travel in the vicinity of the travel path boundary position LP. On the other hand, a state in which the index value sv is greater than or equal to the first threshold value TH1 is, for example, a state in which the variation over time in the travel path boundary position LP is large and there is no stability outside of the travel path boundary position LP. The state in which there is no stability outside of the travel path boundary position LP is, for example, a state in which there is an obstacle on the road shoulder or a state in which the lane adjacent to the outside of the travel lane is a branch lane LC. Therefore, in this case, the control state changer 142 limits the control range and the automated driving control device 100 does not cause the host vehicle M to travel in the vicinity of the travel path boundary position LP.

Specifically, when the left index value svL is greater than or equal to the first threshold value TH1, the control state changer 142 limits the control range of the left direction (hereinafter referred to as a left control range) as compared with when the left index value svL is less than the first threshold value TH1. For example, limiting the left control range is a process of preventing the host vehicle M from traveling in the vicinity of the left travel path boundary position LPL or preventing the host vehicle M from moving in the left direction. For example, when the right index value svR is greater than or equal to the first threshold value TH1, the control state changer 142 limits the control range in the right direction (hereinafter referred to as a right control range) as compared with when the right index value svR is less than the first threshold value TH1. For example, limiting the right control range is a process of preventing the host vehicle M from traveling in the vicinity of the right travel path boundary position LPR or preventing the host vehicle M from moving in the right direction.

The control range may be limited, for example, by making an amount of control assigned to the traveling driving force output device 200 smaller than that in a normal state. The control range may be specified according to the presence or absence of a limit and may be specified step by step or linearly in accordance with the index value sv.

In the example shown in FIG. 8, a waveform W5 is a waveform indicating a setting state of the left control range and a waveform W6 is a waveform indicating a setting state of the right control range. Here, the left index value svL indicated by the waveform W3 exceeds the first threshold value TH1 at time t3. Therefore, the control state changer 142 limits the left control range at time t3. Thereby, in the automated driving control device 100 of the present embodiment, the control state changer 142 can prevent the host vehicle M from traveling or stopping at the travel path boundary position LP (a branch point in the present example) in an unstable state present in front of the host vehicle M and prevent the host vehicle M from interfering with the traveling of another vehicle.

As indicated by the waveform W4 in FIG. 8, the right index value svR does not exceed the first threshold value TH1 at any time. Therefore, the control state changer 142 does not limit the right control range. Thereby, in the automated driving control device 100 of the present embodiment, the control state changer 142 can cause the host vehicle M to travel or stop at the travel path boundary position LP in a stable state present in front of the host vehicle M (i.e., a position suitable for the traveling or stopping of the host vehicle M).

### [Another Example of Limit Position]

Although a case in which the travel path boundary position setter 131 extracts an innermost marker position OP of the marker positions OP every prescribed distance related to the X direction with respect to each of the left and right sides, and sets a position inward separated (offset) by a standard distance from the extracted marker position OP as the travel path boundary position LP in principle has been described above, the present invention is not limited thereto. The travel path boundary position setter 131 may set the marker position OP as the travel path boundary position LP. In this case, the limit line is a line represented by a line connecting the marker positions OP.

### [In Terms of Other Examples of Target Position]

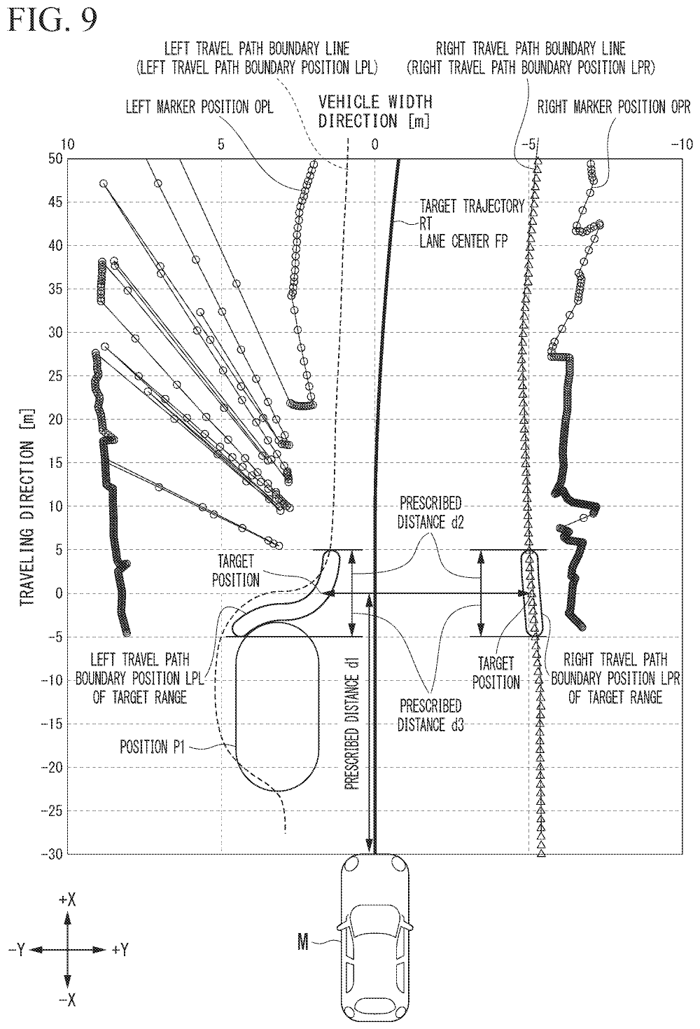

Although a case in which the index value calculator 141 calculates the index value sv on the basis of the travel path boundary position LP of the target position separated by a prescribed distance d1 from the position of the host vehicle M in the forward direction has been described above, the present invention is not limited thereto. FIG. 9 is a diagram schematically showing another example of a process of calculating the index value sv in the index value calculator 141. The index value calculator 141 may calculate the index value sv on the basis of the travel path boundary position LP present in a range (a target range which is shown) from a position separated by a prescribed distance d2 (for example, several to several tens of centimeters [cm]) from the target position in the +X direction to a position separated by a prescribed distance d3 (for example, several to several tens of centimeters [cm]) from the target position in the −X direction. In this case, the index value calculator 141 calculates a statistical value (for example, an average value, a median value, a most frequent value, or the like) of the travel path boundary position LP present in the target range, and calculates a standard deviation of statistical values of a plurality of travel path boundary positions LP acquired from a time which is a prescribed period T earlier than a current time to the current time as the index value sv.

For example, the index value calculator 141 may calculate a standard deviation of a travel path boundary position LP acquired at a certain timing and present in the target range as the index value sv. In this case, lengths of the prescribed distance d2 and the predetermined distance d3 may be any lengths as long as two or more travel path boundary positions LP are included in the target range. In this case, the index value sv is an example of an “index value indicating a variation in a position in the road width direction with respect to a distance from the vehicle in the traveling direction”.

For example, the index value calculator 141 may determine an absolute position in the traveling direction of the host vehicle M and calculate an index value sv on the basis of a plurality of travel path boundary positions LP set in the road width direction of the absolute position. For example, the absolute position is a position separated by a predetermined distance d1 from the host vehicle M in the traveling direction at a certain timing. In this case, the travel path boundary position setter 131 sets the travel path boundary position LP at each prescribed time interval and the index value calculator 141 updates the absolute position at a timing when the host vehicle M has approached a position at a prescribed distance from a certain absolute position.

### Modified Example 1: Exception in Limit of Control Range

Hereinafter, a modified example 1 according to the embodiment of the present invention will be described. In the embodiment, a case in which the control state changer 142 limits the control range when the index value sv is greater than or equal to the first threshold value TH1 has been described. In the modified example 1, a case in which the control state changer 142 does not limit the control range when a prescribed condition is satisfied even if the index value sv is greater than or equal to the first threshold value TH1 will be described. Components similar to the components of the above-described embodiment are denoted by the same reference signs and description thereof will be omitted.

In the modified example 1, the control state changer 142 does not limit the control range even if the index value sv is greater than or equal to the first threshold value TH1 when a condition that the host vehicle M does not interfere with the traveling of another vehicle even if the host vehicle M travels or stops in the vicinity of the travel path boundary position LP, for example, as the prescribed condition, is satisfied. A state in which the prescribed condition is satisfied is, for example, a state in which another vehicle can travel on the left side or the right side of the host vehicle M, for example, even if the host vehicle M travels or stops in the vicinity of the travel path boundary position LP.

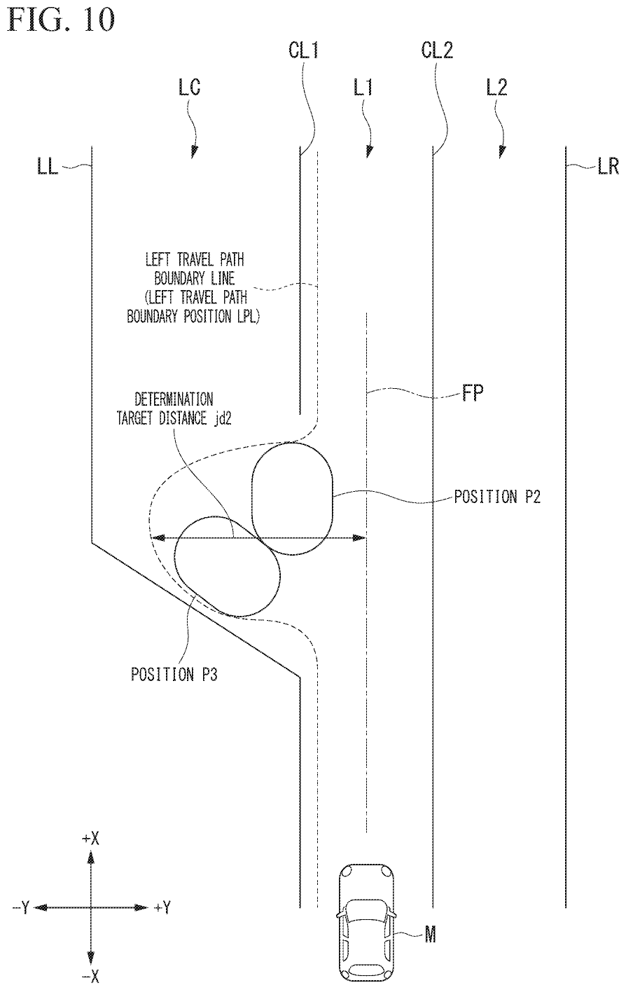

FIG. 10 is a diagram schematically showing another example of a process of limiting a control range. In a scene shown in FIG. 10, for example, a state in which a prescribed condition is satisfied is that a distance from the lane center FP to the limit line (hereinafter referred to as a determination target distance jd2) is greater than or equal to a second threshold value TH2 (for example, several meters [m]). A branch lane LC shown in FIG. 10 is a lane that is wider than the branch lanes LC shown in FIGS. 6 and 7 (for example, the determination target distance jd2 the second threshold value TH2). In this case, even if the host vehicle M travels or stops at a branch point of the branch lane LC (a position P2 which is shown) or in the vicinity of a road dividing line LL (a position P3 which is shown), another vehicle which travels in the branch lane LC can travel on the left side or the right side of the host vehicle M.

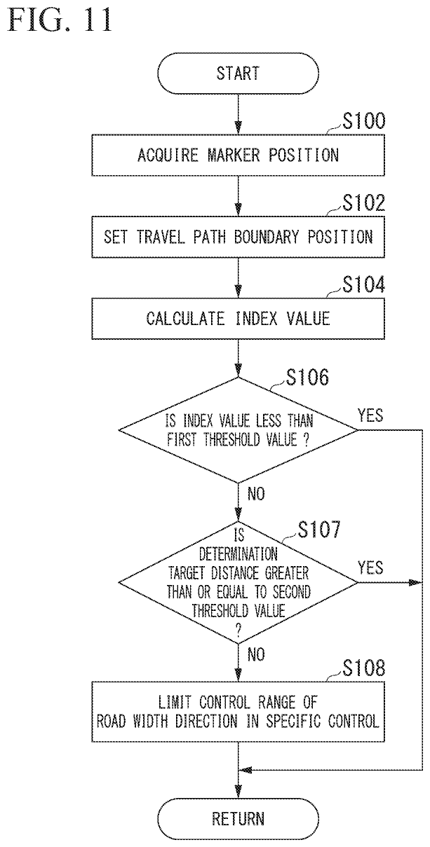

FIG. 11 is a flowchart showing an example of a flow of a process of limiting a control range according to modified example 1. Because the processing of steps S100 to S106 and the processing of step S108 shown in FIG. 11 are similar to the processing matching the step numbers shown in FIG. 4, a description thereof will be omitted.

When it is determined that the index value sv is greater than or equal to the first threshold value TH1, the control state changer 142 determines whether or not the determination target distance jd2 is greater than or equal to the second threshold value TH2 (step S107).

When the control state changer 142 determines that the determination target distance jd2 is not greater than or equal to the second threshold value TH2, the process proceeds to step S108. When it is determined that the determination target distance jd2 is greater than or equal to the second threshold value TH2, the control state changer 142 does not limit the control range in the road width direction. Thereby, in the automated driving control device 100 of the modified example 1, the control state changer 142 can prevent the movement of the host vehicle M from being carelessly limited.

### Modified Example 2: Another Implementation Method for Limiting Control Range

Hereinafter, a modified example 2 according to the embodiment of the present invention will be described. In the embodiment, a case in which the control state changer 142 limits the movement of the host vehicle M in the road width direction by limiting the control range when the index value sv is greater than or equal to the first threshold value TH1 has been described. In the modified example 2, a case in which the travel path boundary position setter 131 limits the movement of the host vehicle M in the road width direction by correcting the travel path boundary position LP inward when the index value sv is greater than or equal to the first threshold value TH1 will be described. Components similar to the components of the above-described embodiment and modified example are denoted by the same reference signs and a description thereof will be omitted.

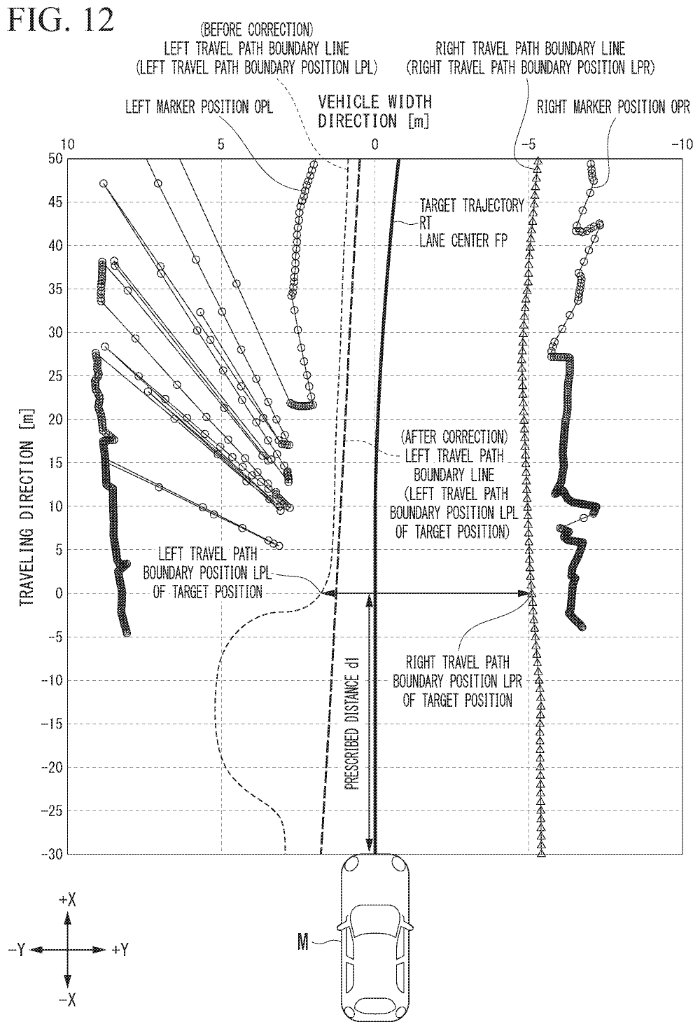

FIG. 12 is a diagram showing an example of the corrected travel path boundary position LP. For example, when the control state changer 142 determines that the index value sv is greater than or equal to the first threshold value TH1, the travel path boundary position setter 131 of modified example 2 inward corrects the travel path boundary position LP to a position for which the index value sv is determined to be less than the first threshold value TH1. As shown in FIG. 12, in this processing, the left travel path boundary position LPL before correction is corrected inward. Thereby, in the automated driving control device 100 of modified example 2, the travel path boundary position setter 131 can prevent the host vehicle M from traveling or stopping at the travel path boundary position LP in an unstable state present in front of the host vehicle M and prevent the host vehicle M from interfering with the traveling of another vehicle.

<In Terms of Limit of Control Range Other than Limit of Control Range when MRM is Executed>

A case in which the control state changer 142 limits the control range based on the index value sv when specific control (for example, MRM) is performed has been described above. Alternatively, the control state changer 142 may limit the control range based on the index value sv all the time.

### <Another Determination Method Related to Limit of Control Range>

Although a case in which the control state changer 142 limits the control range on the basis of the index value sv has been described above, the present invention is not limited thereto. The control state changer 142 may further limit the control range on the basis of, for example, second map information 62. Specifically, even if the index value sv is less than the first threshold value TH1, the control state changer 142 limits the control range when the second map information 62 indicates that there is no adjacent lane or road shoulder outside the left travel path boundary position LPL. Thereby, in the automated driving control device 100 of the present embodiment and the modified example, the control state changer 142 can prevent the host vehicle M from traveling at a position where traveling is impossible.

### [Hardware Configuration]

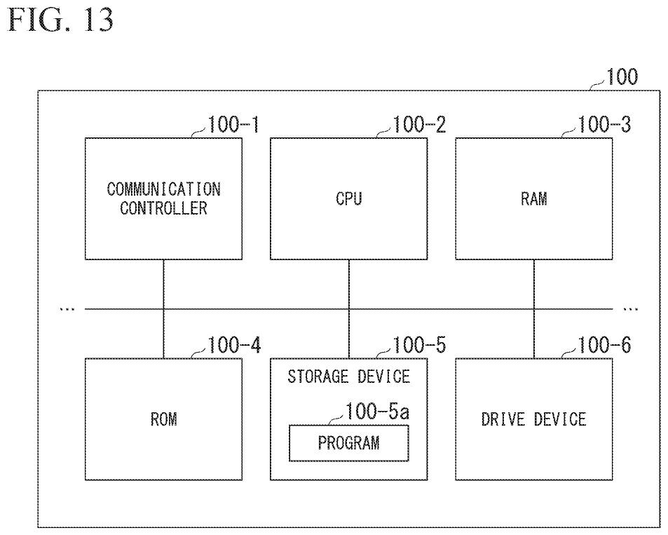

FIG. 13 is a diagram showing an example of a hardware configuration of the automated driving control device 100. As shown, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are mutually connected by an internal bus or a dedicated communication line. The communication controller 100-1 communicates with components other than the automated driving control device 100. A program 100-5a executed by the CPU 100-2 is stored in the storage device 100-5. This program is loaded to the RAM 100-3 by a direct memory access (DMA) controller (not shown) or the like and executed by the CPU 100-2. Thereby, some or all of the recognizer 130, the action plan generator 140, and the second controller 160 are implemented.

The embodiment described above can be implemented as follows.

A vehicle control device including:

a storage device configured to store a program; and

a hardware processor,

wherein the hardware processor is configured to execute the program stored in the storage device to:

set a travel path boundary position that affects vehicle control in a road width direction on the basis of an output of an in-vehicle sensor;

control steering on the basis of the output of the in-vehicle sensor;

calculate an index value indicating a variation over time in the set travel path boundary position or a variation in a position of the road width direction related to a distance from a vehicle in a traveling direction; and

set a control range in the road width direction which is larger when the calculated index value is less than a threshold value than when the index value is greater than or equal to the threshold value.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a travel path boundary position setter configured to set a travel path boundary position that affects vehicle control in a road width direction on the basis of an output of an in-vehicle sensor; and
a driving controller configured to control at least steering on the basis of the output of the in-vehicle sensor,
wherein the driving controller is configured to calculate an index value indicating a variation over time in the travel path boundary position set by the travel path boundary position setter or a variation related to a distance from a vehicle in a traveling direction and set a control range in the road width direction which is larger when the calculated index value is less than a threshold value than when the index value is greater than or equal to the threshold value.

2. The vehicle control device according to claim 1,
wherein the travel path boundary position setter is configured to set the travel path boundary position in an extending direction of a road, and
wherein the driving controller is configured to derive an index value on the basis of a variation in a position corresponding to a prescribed distance in the traveling direction of the vehicle among travel path boundary positions set in the extending direction.

3. The vehicle control device according to claim 1, wherein the in-vehicle sensor includes at least one of a light detection and ranging (LIDAR) finder and an imaging device.

4. The vehicle control device according to claim 1,
wherein the travel path boundary position setter is configured to set the travel path boundary position on each of one side and the other side in the road width direction in the traveling direction of the vehicle,
wherein the driving controller is configured to determine a control range in the road width direction related to a left side of the vehicle on the basis of the index value obtained from a left travel path boundary position set on the left side of the vehicle by the travel path boundary position setter, and
wherein the driving controller is configured to determine a control range in the road width direction related to a right side of the vehicle on the basis of the index value obtained from a right travel path boundary position set on the right side of the vehicle by the travel path boundary position setter.

5. The vehicle control device according to claim 1,
wherein the driving controller is configured to not reduce the control range when the index value is greater than or equal to the threshold value as compared with when the index value is less than the threshold value if a distance in the road width direction between a center of a lane or a central axis of the vehicle and the travel path boundary position is greater than or equal to a prescribed distance.

6. The vehicle control device according to claim 1, further comprising a surrounding environment recognizer configured to recognize a surrounding environment of the vehicle,
wherein the driving controller is configured to activate a first driving state for controlling the vehicle so that the vehicle travels in a lane or along a travel path indicated by a trajectory of a preceding vehicle in front of the vehicle on the basis of a recognition result of the surrounding environment recognizer and a second driving state for causing the vehicle to travel to a travel limit set on the basis of a marker recognized by the surrounding environment recognizer and causing the vehicle to be decelerated or stopped, and
wherein the control range in the road width direction is applied to the second driving state.

7. The vehicle control device according to claim 6, further comprising an estimator configured to estimate a state of a driver of the vehicle,
wherein the driving controller is configured to execute the second driving state when a prescribed state is given.

8. The vehicle control device according to claim 6, wherein the driving controller is configured to execute the second driving state when a driver does not respond to a call of the vehicle.

9. The vehicle control device according to claim 1, wherein the driving controller further is configured to determine the control range in the road width direction on the basis of map information.

10. A vehicle control device comprising:
a travel path boundary position setter configured to set a travel path boundary position that affects vehicle control in a road width direction on the basis of an output of an in-vehicle sensor; and
a calculator configured to calculate an index value indicating a variation over time in the travel path boundary position set by the travel path boundary position setter or a variation in a position of a road width direction related to a distance from a vehicle in a traveling direction,
wherein the travel path boundary position setter corrects the travel path boundary position inward in the road width direction when the index value calculated by the calculator is less than a threshold value as compared with when the index value is greater than or equal to the threshold value at the time of execution of specific vehicle control.

11. A vehicle control method comprising:
setting, by a computer, a travel path boundary position that affects vehicle control in a road width direction on the basis of an output of an in-vehicle sensor;
controlling, by the computer, at least steering on the basis of the output of the in-vehicle sensor;
calculating, by the computer, an index value indicating a variation over time in the set travel path boundary position or a variation in a position of the road width direction related to a distance from a vehicle in a traveling direction; and
setting, by the computer, a control range in the road width direction which is larger when the calculated index value is less than a threshold value than when the index value is greater than or equal to the threshold value.

12. A storage medium storing a program for causing a computer to:
cause a travel path boundary position at which a vehicle is able to travel in a road width direction to be set on the basis of an output of an in-vehicle sensor;
cause at least steering to be controlled on the basis of the output of the in-vehicle sensor;
cause an index value indicating a variation over time in the set travel path boundary position or a variation in a position of the road width direction related to a distance from the vehicle in a traveling direction to be calculated; and
cause a control range in the road width direction which is larger when the calculated index value is less than a threshold value than when the index value is greater than or equal to the threshold value to be set.
